(19) United States
(12) Patent Application Publication
(10) Pub. No.: US 2024/0111907 A1
(43) Pub. Date: Apr. 4, 2024

(54) A DEVICE AND A COMMUNICATION METHOD

(71) Applicant: NCIPHER SECURITY LIMITED, Cambridge (GB)

(72) Inventor: Ian Nigel HARVEY, Cambridge (GB)

(21) Appl. No.: 18/261,505

(22) PCT Filed: Jan. 13, 2022
(86) PCT No.: PCT/GB2022/050074

§ 371 Date: Jul. 14, 2023

(30) Foreign Application Priority Data
Jan. 15, 2021 (EP) 21275002.0

(51) Int. Cl. G06F 21/72; H04L 9/08

(52) U.S. Cl. CPC G06F 21/72; H04L 9/0825; H04L 9/0877

(57) ABSTRACT

A device comprising: an input; a memory; and a processor module; configured to: store information in the memory defining a first isolated environment associated with a first user; responsive to a request received through the input, run the first isolated environment; authenticate the first user in the first isolated environment and, if the first user is authenticated, establish a first secure connection with the first user in the first isolated environment; and responsive to a user command received over the first secure connection; execute, in the first isolated environment, a first operation corresponding to the user command.

### FIELD

The present invention relates to a device and a method of communication. For example, the device may be a hardware security module device.

### BACKGROUND

Various devices may be used to perform cryptographic operations. For example, a hardware security module (HSM) is a device that securely stores and manages cryptographic keys, and performs a set of cryptographic functions. A HSM may comprise both physical and non-physical properties that provide security. Non-physical security properties can include the use of encryption, i.e. the inclusion in the device of software or a physical component to perform encryption of the stored data. Physical security properties can include tamper switches triggered by physical access, and a tamper proof membrane surrounding the physical boundary of the device for example.

Various service providers aim to provide computer implemented services to a large number of users. An example of this is cloud service providers, CSPs, who offer products such as “software as a service” (SaaS) or storage on demand. Use of a service provider hosted computer implemented service allows users to reduce the administrative overhead of hosting such services themselves. Cryptographic services which are hosted by a service provider may use a “single-tenant” solution, deploying a dedicated HSM device per user. This can result in inefficient use of the HSM resources, since each user may not require all of the resources provided by an entire HSM device. Provision of a multi-tenant solution however, in which multiple users use the same HSM device, can introduce a security vulnerability whereby each user must to some extent rely on the service provider to ensure that another user does not have access to their data.

### BRIEF DESCRIPTION OF THE FIGURES

Devices and methods in accordance with non-limiting embodiments will now be described with reference to the accompanying figures in which:

FIG. 1 is a schematic illustration of an example of a hardware security module device;

FIG. 2 is a schematic illustration of an example system comprising a hardware security module device;

FIG. 3 is a schematic illustration of an example system comprising a hardware security module device;

FIG. 4 is a schematic illustration of a hardware security module device in accordance with an embodiment;

FIG. 5 is a schematic illustration of a hardware security module device in accordance with an embodiment;

FIG. 6 is a schematic illustration of various operational layers of a hardware security module running a plurality of containers in accordance with an embodiment;

FIG. 7 shows a flow chart of a method of communication in accordance with an embodiment;

FIG. 8 shows a flow chart of a method of creating a new container on a hardware security module device in accordance with an embodiment;

FIG. 9 is a schematic illustration of a system comprising a hardware security module in accordance with an embodiment together with client systems in communication with the hardware security module;

FIG. 10 is a schematic illustration of a system comprising a hardware security module in accordance with an embodiment and client systems in communication with the hardware security module;

FIG. 11 is a schematic illustration of a system comprising a hardware security module in accordance with an embodiment and client systems in communication with the hardware security module;

FIG. 12 is a schematic illustration of various operational layers of a hardware security module running a plurality of virtual machines in accordance with an embodiment;

FIG. 13 is a schematic illustration of a hardware security module in accordance with an embodiment.

### DETAILED DESCRIPTION

In a first aspect, there is provided a device comprising:
an input;
a memory; and
a processor module, configured to:
   store information in the memory defining a first isolated environment associated with a first user;
   responsive to a request received through the input, run the first isolated environment;
   authenticate the first user in the first isolated environment and, if the first user is authenticated, establish a first secure connection with the first user in the first isolated environment; and
   responsive to a user command received over the first secure connection, execute, in the first isolated environment, a first operation corresponding to the user command.

In an embodiment, the first operation comprises at least one of: cryptographic key generation, cryptographic key derivation, performing an encryption operation; performing a decryption operation and performing a digital signature operation.

In an embodiment, a first master key associated with the first user is stored in the information in the memory defining the first isolated environment.

In an embodiment, the first operation is executed using a first application key, and wherein the first application key is retrieved using the first master key.

In an embodiment, a first public key is stored in the information in the memory defining the first isolation environment, the first public key being part of a first key pair comprising the first public key and a first private key associated with the first user.

In an embodiment, a second private key is stored in the information in the memory defining the first isolated environment, the second private key being part of a second key pair comprising the second private key and a second public key.

In an embodiment, authenticating the first user and establishing the first secure connection comprises:
receiving a communication comprising a first signature from the first user;
validating, in the first isolated environment, the first signature using the first public key;
generating a second signature using the second private key in the first isolated environment;
sending a communication comprising the second signature to the first user.

In an embodiment, authenticating the first user and establishing the first secure connection further comprises:
encrypting a third key using the first public key in the first isolated environment and sending the encrypted third key to the first user, or receiving an encrypted third key from the first user at the first isolated environment and decrypting the encrypted third key using the second private key;
wherein the third key is used to encrypt communications between the first user and the first isolated environment thus providing the first secure connection.

In an embodiment, the information in the memory defining the first isolated environment comprises information identifying program instructions which, when executed, cause the processor to perform the first operation.

In an embodiment, a first version of the program instructions and a second version of the program instructions are stored in the memory, and wherein the information identifying the program instructions comprises an indication of the first version.

In an embodiment, the processor module is further configured to:
store information in the memory defining a second isolated environment associated with a second user;
responsive to a request received through the input, run the second isolated environment;
authenticate the second user in the second isolated environment and, if the second user is authenticated, establish a second secure connection with the second user in the second isolated environment; and
responsive to a user command received over the second secure connection, execute, in the second isolated environment, a second operation corresponding to the user command.

In an embodiment, the information stored in the memory defining the first isolated environment associated with the first user comprises an encrypted file.

In an embodiment, the device is a hardware security module.

In an embodiment, the processor module is further configured to: responsive to a request received through the input, authenticate a first host outside the first isolated environment, and if the first host is authenticated, establish a second secure connection with the first host; and run a first process outside of the isolated environment. In a further embodiment, the processor module is further configured to: responsive to a request received through the input, authenticate a second host, and if the second host is authenticated, establish a third secure connection with the second host; and run a second process outside of the isolated environment.

In an embodiment, the first process is an administrative process. In an embodiment, a credential used to authenticate the first secure connection cannot authenticate the second secure connection, and a credential used to authenticate the second secure connection cannot authenticate the first secure connection.

In an embodiment, authenticating the first user in the first isolated environment comprises authenticating a first entity associated with the first user, and the processor module is further configured to: authenticate a second entity associated with the first user in the first isolated environment and, if the second entity is authenticated, establish a second secure connection with the second entity in the first isolated environment; and responsive to a user command received over the second secure connection, execute, in the first isolated environment, a second operation corresponding to the user command.

In a further aspect, there is provided a system comprising the above device and a first user device, wherein the first user device operates a shielded virtual machine, and wherein the first private key is stored in the shielded virtual machine.

In a further aspect, there is provided a method of communication, comprising:
running a first isolated environment corresponding to a first user on a device in response to receiving a request;
authenticating the first user in the first isolated environment and, if the first user is authenticated, establishing a first secure connection with the first user in the first isolated environment;
receiving a user command over the first secure connection; and
executing, in the first isolated environment, a first operation corresponding to the user command.

In an embodiment, a first asymmetric key pair comprises a first public key stored in the first isolated environment and a first private key associated with the first user and wherein authenticating the first user and establishing the first secure connection comprises:
validating a signature of the first user with the first public key;
exchanging one or more encryption keys with the first user.

In an embodiment, the method further comprising:
running a second isolated environment corresponding to a second user on the device in response to receiving a request;
authenticating the second user in the second isolated environment and, if the second user is authenticated, establishing a second secure connection with the second user in the second isolated environment;
receiving a user command over the second secure connection; and
executing, in the second isolated environment, a second operation corresponding to the user command.

In an embodiment, the first isolated environment is also associated with a second user, the method further comprising:
authenticating the second user in the first isolated environment and, if the second user is authenticated, establishing a second secure connection with the second user in the first isolated environment;
receiving a second user command over the second secure connection; and
executing, in the first isolated environment, a second operation corresponding to the second user command.

In an embodiment, the method of creating an isolated environment, comprising:
receiving a request to create an isolated environment associated with a first user;
creating the first isolated environment associated with the first user;
establishing a secure connection with the first user in the first isolated environment;
receiving information allowing performance of one or more operations in relation to the first user over the secure connection.

In a further aspect, there is provided a carrier medium comprising computer readable code configured to cause a computer to perform any of the above methods.

In a further aspect, there is provided a non-transitory computer readable storage medium comprising program instructions stored thereon that are executable by a computer processor to perform any of the above methods.

The methods are computer-implemented methods. Since some methods in accordance with embodiments can be implemented by software, some embodiments encompass computer code provided to a general purpose computer on any suitable carrier medium. The carrier medium can comprise any storage medium such as a CD ROM, a magnetic device or a programmable memory device, or any transient medium such as any signal e.g. an electrical, optical or microwave signal. The carrier medium may comprise a non-transitory computer readable storage medium. In a further aspect of the present invention, there is provided a carrier medium comprising computer readable code configured to cause a computer to perform any of the methods described.

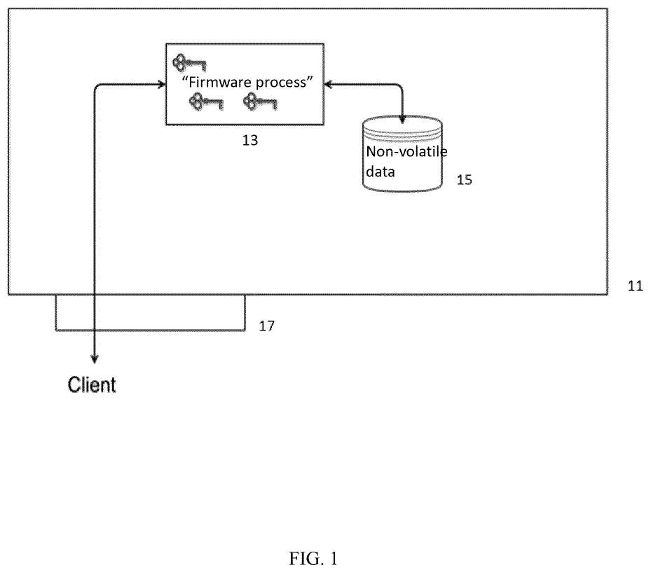

FIG. 1 is a schematic illustration of a hardware security module 11. The figure shows a high level schematic illustrating the use of the hardware security module 11 to perform one or more cryptographic functions for a client. The term client is used throughout the description to refer generally to a user of a HSM device.

The HSM 11 comprises a processor (not shown) which is configured to execute programs stored in memory on the HSM 11. The programs are referred to as “firmware” in the below description, however generally the programs comprise a set of computer instructions stored in non-volatile memory on the HSM device 11 and embodying the functionality as will be described in relation to the “firmware” below. The computer instructions, or firmware, may be written in any of a number of programming languages, and may be stored on the HSM device 21 as compiled code.

The figure shows a “firmware” process 13 associated with the client. A “process” refers to a program in execution, in other words it is a running instance of the firmware.

The processor runs an operating system, for example a Linux operating system. However, it is understood that the processor could run other operating systems, such as Windows. The Linux operating system comprises system software that manages the hardware and software resources of the HSM device 11, and acts as an intermediary between the firmware (and other applications) and the HSM hardware.

The firmware comprises computer instructions embodying a set of one or more cryptographic functions. For example, the firmware comprises computer instructions embodying one or more of the following cryptographic functions: cryptographic key generation; cryptographic key derivation; encryption; decryption; and digital signature functions (for example digital signing or validation of a digital signature).

The HSM device 11 is located in a host system (not shown), for example a service provider system. The HSM 11 is communicatively coupled to a computer or server device in the host system, via host interface 17. For example, the HSM device 11 may be a PCI-express card, directly plugged in to a PCI-express card slot of the host system device. Alternatively, the HSM device 11 can be coupled by a USB connection for example. The host system may comprise a large number of HSM devices coupled to the computer or server device.

A client system, which is separate to the host system, is located remotely from the host system. The client system comprises a computing device or server device. The client system is communicatively coupled to the computer or server device in the host system, and thus is communicatively coupled to the HSM device 11 through the computer or server device in the host system. Communication between the client system and the host system is performed over a communication network. Communication between the client system and the host system may be performed via an Internet connection for example.

In use, the host system receives one or more requests from the client system. The HSM device 11 receives the client requests through host interface 17. The requests correspond to performance of one or more cryptographic functions such as: cryptographic key generation; cryptographic key derivation; encryption: decryption and digital signature functions (for example digital signing or validation of a digital signature). The requests are generated using a communication protocol. The HSM device 11 runs a Linux process, also referred to as /usr/bin/firmware or the “firmware process”, which executes the commands given to it by the client.

The firmware process has an associated non-volatile data store 15, in other words part of the non-volatile memory of the HSM device 11 is assigned to the firmware process. The non-volatile data store 15 stores data items such as one or more master keys associated with the client.

The master keys stored in the non-volatile data storage 15 may comprise a Security Officer Key, which is referred to as the ‘KNSO’ key in the below description. This key defines the root-of-trust used to authorise all management operations of the hardware security module 11, such as changing the configuration settings of the hardware security module 11, and file management operations.

The master keys stored on the non-volatile data storage 15 may additionally or alternatively comprise a Module Security World Key, which is referred to as the ‘KMSW’ key or ‘module key’ in the below description. This is a symmetric key used as a root for other application keys. There are a number of cryptographic application keys associated with the client and for use with the cryptographic functions embodied in the firmware process. The application keys may be securely stored outside of the HSM device 11. The application keys may be encrypted using the Advanced Encryption Standard (AES) for example. Alternatively, Triple-DES encryption may be used. Each application key may be associated with an Access Control List which is also encrypted. The key and ACL are encrypted together and the result is signed with the KMSW module key. This forms a “key blob”. Encrypted and protected key blobs can be stored outside the HSM device 11, either on smart cards or server storage such as hard discs within the host system for example. Alternatively, the application keys may be stored on the HSM device 11, in the non-volatile data storage 15.

The master key or keys define a “security world” associated with the client, in which the HSM device 11 is enrolled. The term “security world” refers to one or more security appliances (for example HSMs), or parts of a security appliance (for example containers as described below), which share at least one private key and are configured to safeguard cryptographic keys and perform a set of cryptographic functions.

The application keys associated with the client device are used to perform one or more cryptographic functions embodied in the firmware process. When a client request is received, the application keys are retrieved using the KMSW module key, and loaded into the RAM space of the firmware process.

In this figure, details like the Linux kernel, PCI-express drivers, and firmware upgrade mechanism have been left out for clarity.

FIG. 1 illustrates the hardware security module 11 operating in a single-tenant configuration i.e. the HSM is dedicated to a single client. The host system therefore comprises a separate HSM device for each client. This can result in inefficient use of the HSM resources, since each client may not require all of the memory and processing resources provided by the HSM device.

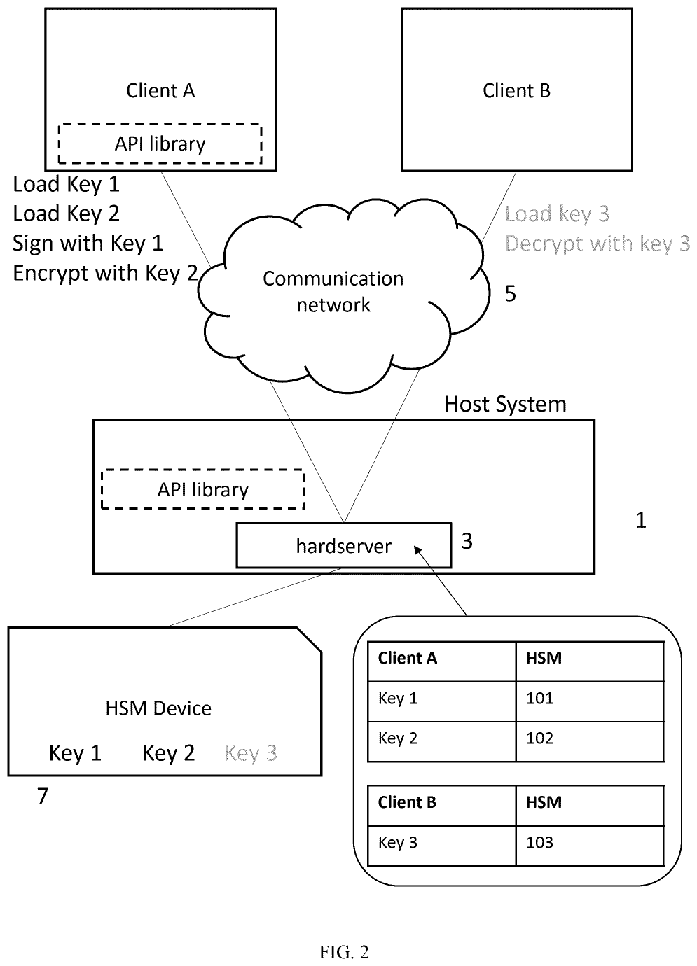

Alternatively, a single hardware security module device 7 may be used for multiple clients in the manner illustrated in FIG. 2. In this case, the HSM device 7 stores the master key or keys corresponding to multiple clients, client A and client B. The HSM device 7 is thus enrolled in multiple security worlds. As has been described above, the HSM 7 is coupled to a computer or server device 1 in the host system. Client A and client B are communicatively coupled to the computer or server device 1 in the host system and communicate with the device 1 through communication network 5. When a client request is received at the device 1 in the host system, software running on the device 1 is used to determine which set of one or more master keys stored in the memory of the HSM device 11 correspond to the client. This software is referred to as the “hardserver” software.

A client sends one or more commands. Example commands sent from each client are shown in the figure, where client A sends a list of commands comprising “Load Key 1, Load Key 2, Sign with Key 1, Encrypt with Key 2”, and client B send a list of commands comprising “Load key 3, Decrypt with key 3”. Client A and Client B use a communication protocol to send these commands. Client A stores an API library on the client device, which is used to generate commands complying with the communication protocol. The communication protocol is also used by the hardserver process 3 running on the host system device 1. The host system device 1 therefore may also store an API library, or may use a Web API. Client B in this case uses a Web API.

Client separation is implemented in the hardserver process 3, running on the device 1 in the host system. Individual clients connect to the hardserver process 3 using named pipes or sockets for example, making use of operating system provided separation mechanisms in the device 1 in the host system. The hardserver process 3 uses the named pipes or sockets to identify the source of the commands. The hardserver process 3 makes use of a stored look-up table on the host device 1, which lists the keys (i.e. the key names, rather than the key material) corresponding to each client, together with some identifier of the key used by the HSM device 7. The hardserver process 3 verifies that the client commands are requesting use of keys which are associated with that client. For example, client A sends a command to Load Key 1. The hardserver process confirms that the request comes from client A based on the pipe or socket, and then confirms that Key 1 is stored in the look-up table associated with client A. Since Key 1 is stored in the look-up table associated with client A, the hardserver process 3 sends the command to the HSM device 7, together with the stored HSM identifier for Key 1 (which may be a bit string label—101 in this case). The identifier is then used by the HSM device 7 to retrieve the correct key.

The administrator of the host operating system is trusted to ensure this is configured correctly, so that a client does not have privileges required to impersonate another client. This means that each tenant relies on the host system administrator to ensure that another client does not have access to their master keys. It also means that the host system administrator is involved in the management of individual client cryptographic applications.

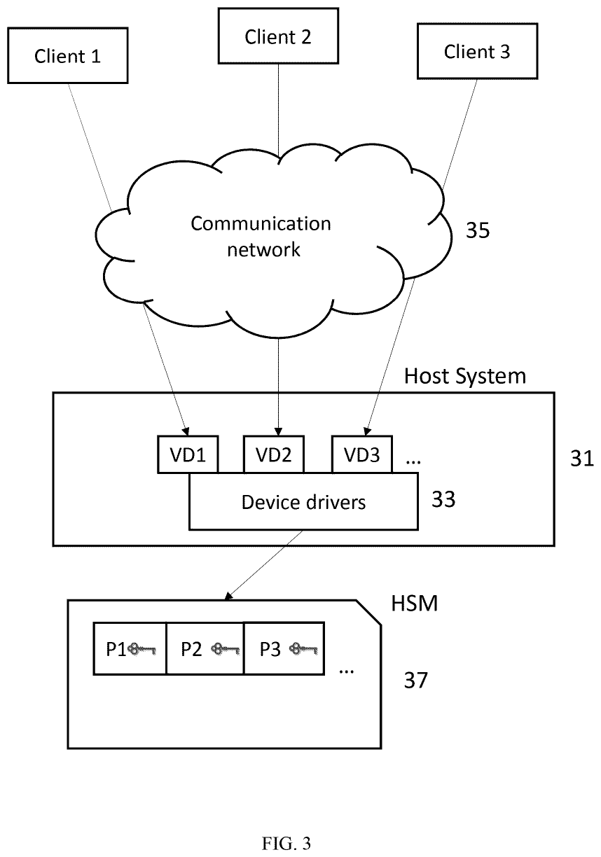

Alternatively, multi-tenancy may be implemented through hardware partitioning of the HSM device 11. FIG. 3 is a schematic illustration of a system comprising an HSM device 37 divided into partitions P1, P2 and P3. Each partition corresponds to a portion of memory of the HSM. In other words, a portion of the non-volatile memory and a portion of the RAM is assigned to each partition. The partitions can be implemented in software, for example a disk with multiple directories. Once defined, the use of the allocated memory resource is restricted only to the associated partition. Thus each partition always uses a separate part of memory. Each partition then acts as a separate HSM device. A fixed number of partitions are created on the device at set up. Partitions may not necessarily have fixed allocations of resources however.

In FIG. 3, partition P1 is allocated to client 1, partition P2 is allocated to client 2, and partition P3 is allocated to client 3. The partition stores all of the master keys associated with the particular client. In the host device 31, each client is associated with a virtual device VD1, VD2, and VD3. These virtual devices are defined in software on the host device 31. As described above, device 31 in the host system uses named pipes, sockets or other host operating system functionality to determine from which client each request originates, and match the request to the corresponding virtual device. Processes for client 1 make direct connections to the virtual device VD1. However, the host operating system is still responsible for separation, rather than the HSM device 37.

A device driver 33 also runs on the host system device 31. The driver 33 provides a software interface to the partitions P1, P2 and P3, enabling the host device 31 operating system and other computer programs running on the host device 31 to access the HSM functions. Each partition appears as a separate HSM through the device driver 33. Thus each partition appears as a separate HSM to the operating system running on the host device 31. Each virtual device is associated with a separate partition through the device driver 33. A received client command at the host system device 31 is therefore matched to the corresponding virtual device, and then to the associated partition in the device driver. The matching of the client with the corresponding virtual device is done by the host operating system. All clients must therefore still trust the administrator of the host system to configure this matching correctly. The command is then sent to the HSM, with the partition identifier at the start.

In this scenario, clients have access to only the partition(s) specifically dedicated to them and can only use the hardware resources of the partition(s) specifically assigned to them. This can again result in inefficient use of the HSM resources, since each client may not require all of the memory and processing resources provided by a partition at all times. Furthermore, if additional resources are required by the client, a further partition must then be assigned to the client, which may be located in a different HSM device for example. Where two or more partitions are allocated to the same client, each partition must store all of the client master keys, making inefficient use of the memory resources of the hardware security modules. Furthermore, the security again relies on the host to associate the correct partition with each client.

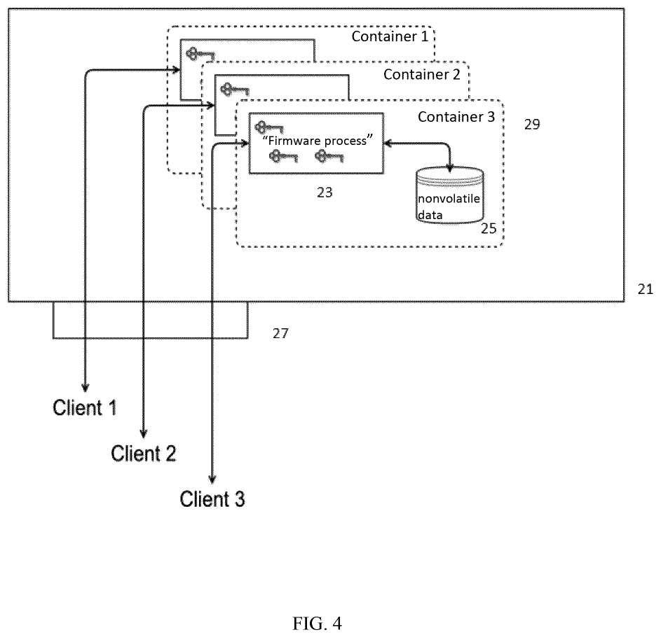

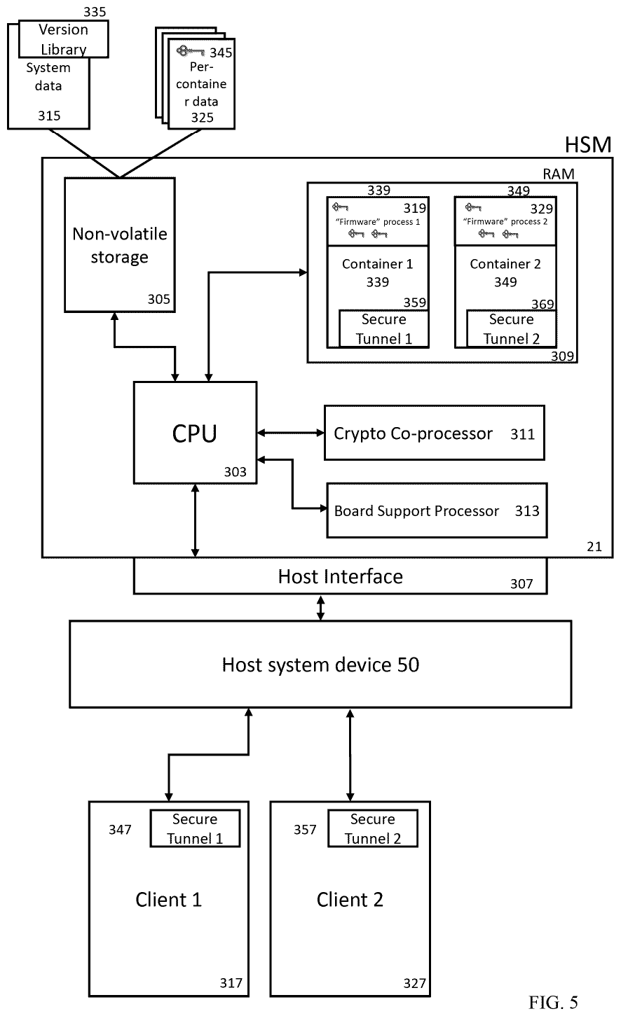

FIG. 4 shows a schematic illustration of a hardware security module 21 in accordance with an embodiment. The figure shows a high level schematic. The firmware process and its non-volatile data for each client are put in a separate container 29. FIG. 5 is a schematic illustration of the various internal hardware components of the hardware security module 21 shown in FIG. 4. For clarity, only two containers are shown running in FIG. 5 (whereas FIG. 4 shows three containers running). A container is an example of an isolated environment. The container isolates one or more running processes from the rest of the system.

A file corresponding to the container is stored in the non-volatile memory 305 of the HSM device 21, in the “per-container” data 325 shown in FIG. 5. This file may also be referred to as the container image or container repository. When run, the container image becomes the container. The container image comprises the program code corresponding to the programs to be run in the container (or a reference allowing the relevant program code to be retrieved). This includes the firmware (or a reference to the firmware) and an SSH server. The SSH server is a program which uses the secure shell protocol to accept connections, and will be described in more detail below. The container image further comprises all libraries, supporting files and programs, and any language interpreter required to run these programs on the HSM device 21. This means that when the container is running, the programs may run without requiring access to files outside the container. The container image also stores the master keys associated with the client.

When a command to start a container is received at the HSM device 21, a container engine retrieves the container image, then makes one or more API calls to the operating system kernel. The kernel implements the isolation of the container, and enforces the part of the non-volatile memory 325 (the container image) and network connections available to the container. The kernel, together with the memory management unit within the CPU, allocates part of the RAM to the container, and prevents writing to other parts of the RAM. In this way, the container isolation is implemented by the operating system kernel, using the hardware components such as the memory management unit.

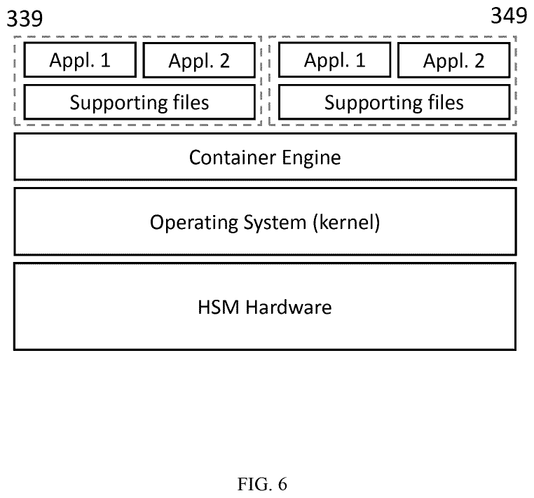

Once running, a container is a set of one or more processes that are isolated from the rest of the system. The container engine comprises a set of program instructions that retrieve the container image in response to a command to start a container, and initiates and runs the container (the running processes) by making one or more API call to the operation system kernel. FIG. 6 is a schematic illustration of two containers running on the HSM device 21. The figure shows the operating system kernel running on the HSM hardware, the container engine, and a first container 339 and a second container 349 that share the operating system kernel. The first container 339 comprises application 1, application 2 and the supporting files for these applications. The second container 349 comprises application 1, application 2 and the supporting files for these applications.

Various known container engines may be used. Examples of container engines include Docker, Linux LXC and Linux LXD. Various known formats for the files in the container image may be used, for example Docker V2 image manifest.

Referring to FIG. 4, the containers 29, once running, each comprise the firmware process 23 associated with the individual client. Each container corresponds to a segment of the non-volatile memory 25, where the critical data defining the security world in which the container 29 is enrolled is stored. The containers provide multiple copies of the supporting files and libraries required to run the firmware process, providing good isolation. Furthermore, different versions of the firmware may be used by different containers, since each container comprises the relevant supporting files and libraries needed to run the processes desired for that container. FIG. 4 shows three containers (boundary marked with a dotted line).

Each container corresponds to separate non-volatile data. This non-volatile data includes all the data describing a security world, thus each container can belong to a different security world. For example, the KNSO key and the KMSW module key are fully separate between containers. Deployments with many security worlds can therefore run with fewer HSMs, as several security worlds can be condensed onto one HSM. The security worlds can be run at different times, when requested by different clients.

Each container comprises its own copy of the firmware process, running in an isolated memory space. In the event of a firmware vulnerability which causes a leak of key data, e.g. through revealing uninitialized memory contents, only the key data visible to that particular instance of the firmware process could be compromised.

This also means that the “firmware” process running in each container does not need to be the same version of the code. Each container is isolated from the others, and has limited and well-defined dependencies on anything outside the container, as explained above with reference to FIGS. 5 and 6. It will be possible for some clients to run old versions of the firmware process, while others can run the latest version. For example, clients may integrate an HSM with a much bigger system, and qualify a particular firmware version as part of the system configuration. A host-implemented change to the firmware version in the HSM would then require the client to perform a wider system test. However, by allowing each container to have its own firmware version, clients can elect to perform a firmware upgrade at a convenient time, such that consistency with the rest of the client system is maintained. Similarly, there is no obligation for a host system administrator to decide when firmware upgrades should be applied, and to manage the impact of this on multiple client systems.

It is often desirable to run a trial of new firmware versions, while retaining the ability to revert to an older version if problems are discovered. However, the ability to revert firmware versions conflicts with the need to have some “rollback protection”, where a new version shouldn't be replaced by an older, possibly less secure, version. A client can create a second container comprising the new firmware version, alongside the existing container with the current firmware version, and then choose to delete the old container if the trials are successful, or remove the new container if not.

Furthermore, individual firmware versions are often subject to regulatory approval, such as FIPS 140-2 or Common Criteria for example. These approvals take time and effort, with the result that latest firmware versions containing new features can be “unapproved” for a considerable time after they become available. Allowing multiple firmware versions eliminates the conflict between the need for latest features, and the need for an “approved” firmware version, since these can be run in parallel. The hardware security module can support both a version of the firmware which complies with the regulatory criteria, and a version of the firmware which is not constrained by the requirements of the regulators, by running each in a separate container. The ability to run ‘latest’ firmware alongside ‘stable’ firmware, on the same HSM is thus provided. The ease of creating additional security worlds means that FIPS-3 or Common Criteria modes can be used without impacting existing applications.

The latest firmware version generally contains backwards-compatibility code, to allow operation with old security world data. This makes the development and testing process more complicated, and means the ‘attack surface’ of the firmware gets ever larger as support for old cryptographic mechanisms is retained. Using one firmware version for each container allows the possibility of removing legacy support in future firmware versions, while still allowing older security worlds to be supported on the HSM itself.

Furthermore, each container has its own resource limits. For example, where Linux containers are used, Linux container technology provides flexible controls for limiting the CPU and memory use for each container. The ability to monitor and control resource usage by each client is also provided. The resource limits associated with each Linux container are defined in a control file, which is stored outside of the container image. The container engine provides tools for accessing the control file at any time and changing the resource limits. This may be done while the HSM is running and without having to reinitialise the hardware security module. The resource limits defined in the control file are then enforced by the kernel.

The firmware itself may also have performance-shaping code to limit the maximum usage of the cryptographic co-processor for example, which can be set by the HSM administrator. The crypto co-processor, also referred to as the crypto accelerator, will be described with reference to FIG. 5 below.

As described above, FIG. 5 is a schematic illustration of various internal hardware components of the hardware security module 21 shown in FIG. 4 in more detail. The hardware security module 21 comprises a central processing unit (CPU) 303. The CPU 303 runs a Linux operating system, however, the CPU 303 may support other operating systems. Alternatively, if the CPU 303 runs Windows OS, a virtual machine running Linux OS can be run such that a Linux LXC container engine can be used. The CPU 303 is in wired bi-directional communication with non-volatile storage 305 and in wired bi-directional communication with working memory 309, corresponding to Random Access Memory. RAM 309 corresponds to operating memory of the CPU 303.

The non-volatile memory 305 may include any form of non-volatile device memory such as flash, optical disks or magnetic hard drives for example. The non-volatile memory 305 may be physically secure and may be resistant to tamper by a third party, for example by the inclusion of physical security such as a membrane that covers the entire device, that cannot be removed without destroying the underlying physical hardware, thus making it un-usable.

The processor 303 is coupled to the storage 305 and accesses the working memory 309. The processor 303 may comprise logic circuitry that responds to and processes the instructions in code stored in the working memory 309. In particular, when executed, a program is represented as a software product, or process, stored in the working memory 309. Execution of various programs by the processor 303 will cause methods as described herein to be implemented.

The firmware may be in the form of compiled code. The firmware can be embedded in the hardware security module when manufactured, or can be provided, as a whole or in part, after manufacture. For instance, the firmware can be introduced as a computer program product, which may be in the form of a download. Alternatively, modifications to existing firmware can be made by an update, or plug-in. In order to enforce security, only software from a trusted party is accepted. Digital signing processes can be used to enforce this, and the software may be provided in a command through the host system device.

The non-volatile storage 305 stores system data 315 and per-container data 325. The per-container data 325 comprises information associated with the corresponding container. This is wrapped into a single file, also referred to as the container image. Each container uses its own encryption key, referred to here as the container key, to encrypt information stored in that container. The security world keys in the container are encrypted with the container key. The container key may encrypt the entire container file, or it may encrypt certain data within the container file, for example the security world keys. The container key is stored in the hardware security module 21. For example, the container key may be stored in the system data 315. In one example, the container key is split into a plurality of separate parts and the separate parts of the container key are stored in different components of the hardware security module 21. For example, the container key is split into three parts and each part of the container key stored in one of the system data 315 in the non-volatile storage 305, the board support processor 313, and a non-volatile storage area of the CPU 303 itself. The separate parts are combined in the working memory 309 when needed to access the container data, to form the final container key. Separating the container key into different parts makes it harder for the complete key to be extracted through physical disassembly of the HSM device 21.

In particular, the per-container data comprises one or more master keys as have been described previously. The one or more master keys 345 define the security world which is associated with the particular client of the hardware security module 21. The one or more master keys may comprise a KNSO key and/or a KMSW module key. The application keys associated with the client and for use with the firmware cryptographic functions are encrypted and stored outside the HSM device 11 as has been described previously.

The per-container data also comprises information which may be used to establish a secure connection with the corresponding client system. For example, the per-container data may comprise a first public key from a first public-private key pair, where the first private key is accessible only to the corresponding client. For example, the first private key may be stored on the client system, or stored on a separate system in an encrypted manner such that it may be accessed only by the client. The per-container data may also comprise a second private key from a second public-private key pair, where the second public key is provided to the client. The per container data 325 may further comprise software for establishing the secure connection with the client system. For example, a Secure Shell (SSH) protocol may be used to provide a secure connection. The per-container data comprises an SSH server, together with a container SSH key pair, and the public key of a client SSH key pair.

The per-container data may also include the firmware, or information identifying the firmware used by the container. For example, the information may identify the version of the firmware to be used by the container, from a number of versions of the firmware which are stored on the HSM device 21. Alternatively, the information may comprise attributes of the firmware, for example “latest version”. In this manner, it is avoided storing a copy of the firmware for each container, thus reducing the non-volatile storage memory requirement for each container.

A HSM device may have 8 GB of RAM space for example. HSM devices with 16 GB of RAM or more are also available. The non-volatile data corresponding to each container may be 10 KB or less, so that hundreds or thousands of security worlds can be supported in a single HSM device. However, this may not be practical if each container has its own copy of the firmware it is running. The size of the firmware may be between 1 and 10s of megabytes for example. The HSM 21 may therefore have a “firmware version library” which contains one copy of each supported firmware version. The container data then indicates which version it is using, and this version is retrieved based on the indication and loaded into the container when it is run.

Clients can request a specific version number to be associated with a container. Alternatively, they can also describe a firmware version by its attributes. The HSM will pick the latest (or “best”) firmware version in the library which matches those attributes. These would be specified in a configuration file associated with the container. For instance, the configuration file could specify “the latest version which is FIPS approved”, or “the last version to support V2 Security Worlds”. Whenever a firmware update is available, and added to the version library, containers can be automatically upgraded to this version if it matches the requested attributes. In other words, when the container is run, the latest version that matches the attributes will be retrieved. This change to the latest version does not require the presentation of administrator cards. Each client thus does not have to request an upgrade to ensure they are running the latest fully-patched firmware, but can be confident that it still meets their own individual requirements.

The system data 315 may comprise a firmware version library 335, comprising a copy of each version of the firmware supported by the hardware security module 21. The host system administrator has access to the firmware version library 335 and can add and/or remove firmware versions from the library, thus administer the firmware versions available to the clients and controlling which versions are available to clients. The system data 315 may also comprise the serial number of the hardware security module, manufacturer's certificates and any keys associated with the manufacturer security keys for example.

As described above, the storage size required for the non-volatile data associated with each container (i.e. the per container data) may be 10 KB or less. This means that many security world datasets can be kept in the HSM device non-volatile storage. In other words, many sets of per container data may be stored. Each container can be run as and when needed, when a request from the corresponding client is received. Even in a large deployment, e.g. a large host system with multiple HSM devices and many clients, each client's non-volatile data can be installed on every HSM device. This allows operational capacity to be easily scaled on demand. For example, hundreds or even thousands of security world datasets may be stored on a single HSM device. The storage capacity for multiple tenant data on each HSM allows effective dynamic scaling. Where a host system comprises multiple HSM devices, load balancing software running on a computer or server device in the host system is used to direct to client requests to a HSM having available resources.

The HSM device 21 has an internal architecture, comprising multiple isolated environments, that allows the HSM to behave like many individual HSMs, inside a single hardware unit.

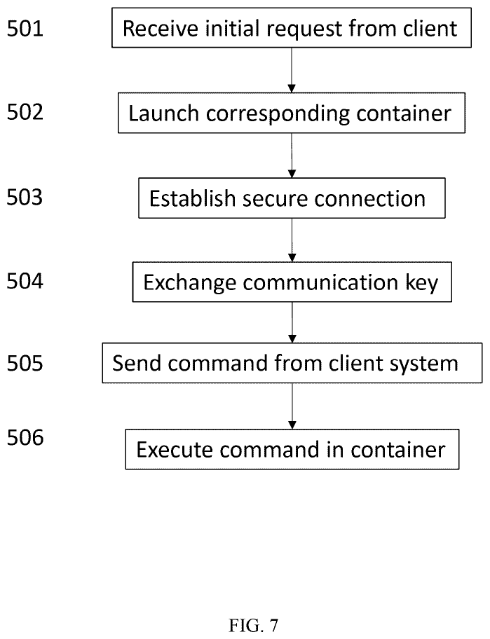

The process that occurs when a client request is received is described in detail in relation to FIG. 7 below. When a client request is received at the host system device 50, the container corresponding to the client is identified. A request to run the container is then sent to the HSM device 21. The container is then run. A section of the RAM 309 is allocated to the container. The files in the container image are loaded into the section of the RAM 309. Where the firmware is identified by a reference stored in the container image (rather than being part of the container image), the firmware identified by the corresponding container information 325 stored in the non-volatile memory 305 is loaded into the container. The application keys are retrieved using the module key stored in the container information 325 in the non-volatile memory 305, and also loaded into the container. The SSH server, together with the information for establishing the secure connection stored in the container information 325 in the non-volatile memory 305 is also loaded into the container.

FIG. 5 illustrates two containers, container 1 339 and container 2 349 defined in the RAM 309. In the figure, container 1 339 and container 2 349 are represented as occupying the same amount of RAM space, however, it is to be understood that each container has its own resource limits, stored in a control file as explained above, and container 1 may require more operating memory than container 2 or vice versa. Container 1 corresponds to client 1 and container 2 corresponds to client 2. Client 1 system 317 and client 2 system 327 are also shown. As has been described previously, the client systems communicate with the HSM device 21 through a host device 50. The CPU 303 is configured to allocate a section of RAM to each container when initialised as described previously. Although the term “section of RAM” is used, it is understood that each container does not necessarily occupy a single physical location in the RAM. Rather, parts of the RAM may be allocated to one container when initialised.

While there is isolation of the memory space in which the containers 339 and 349 are running, containers 339 and 349 share the operating system kernel, as shown in FIG. 6. While the operating system is shared among the containers, the container architecture allows for the application processes of each container to be isolated from the rest of the system and the rest of the application processes. The shared operating system renders the containers lightweight to the system resources, which itself allows for fast operation including for initiation of the containers. Furthermore, the shared operating system allows containers to reduce the management overhead, as the hardware security module 301 only manages a single operating system. Containers share the same operating system kernel and isolate the application processes from the rest of the system. Containers may be used with various operating systems, but they are compatible with the underlying operating system.

When a new container is initiated, the indication of the firmware version stored in the per-container information 325 is used to obtain the firmware version from a firmware version library 335, which is part of the system data 315, and the selected version of the firmware is loaded into the container space in the RAM by the container engine. The RAM 309 is allocated to each container based on the resources required by the container in order to properly execute the corresponding firmware process and other processes.

Where the indication of the firmware version comprises one or more attributes, rather than a reference to a specific version, a program provided by a trusted party and running on the HSM device reviews the one or more attributes and selects the version of the firmware stored in the system data which best matches the specified attributes. For example, client 1 can request that their container is running “the last version to support V2 Security Worlds” or “the latest version which is FIPS approved”. These client requests are saved in the per-container data 325 of the container associated with client 1. When a new version of the firmware is added to the firmware version library 335 by the host system administrator, the container will automatically comprise a firmware process corresponding to the latest version of the firmware if it matches the attributes.

Containers 339 and 349 comprise a firmware process 319 and 329, respectively, which have been loaded in the containers from the firmware version library at their initiation. At initiation, one or more master keys associated with the container, are loaded into the container from the per-container data section 325 of the non-volatile storage block 305. For example, a module key associated with the client is loaded into the container and is used to retrieve the client application keys. When the application keys are loaded into the corresponding container, there are stored into the operating memory space of the firmware process. The application keys may be used by the hardware security module to perform one or more functions, including performing various encryption and decryption operations, and performing digital signature operations.

The HSM device 11 further comprises a board support processor 313. Board support processor 313 is configured to communicate with a plurality of on-board sensors, monitoring the operation of the main CPU and the other hardware components of the hardware security module 21. The sensors may include but are not limited to CPU and/or board temperature sensors, voltage and/or current sensors.

The HSM device 21 further comprises a crypto accelerator 311. The crypto accelerator performs specific cryptographic operations. Requests for performance of an operation are passed from the CPU 303, and the crypto accelerator 311 returns to the CPU 303 a response to the request.

CPU 303 is configured to receive user requests through host interface 307. The processor 303 accesses the interface. The interface 307 may be a single component or may comprise various components. The HSM 21 is coupled to a computer or server device 50 in the host system through the host interface. The host interface may comprise a communication port, which provides a PCI-e bus connection to the computer or server device 50 in the host system.

It is to be understood that one, two, or more than two clients can use the HSM device 21 at one time.

FIG. 7 shows a flow chart of a method of communication using a hardware security module device in accordance with an embodiment. The method may be performed using a hardware security module device such as shown in FIGS. 4 to 6 above for example.

In step 501, an initial request is received from a client system at the device 50 in the host system. The initial request comprises information identifying the client. The host system device 50 stores a look-up table enabling the container corresponding to a particular client to be identified. The host system device 50 sends a request to the HSM device to run the container corresponding to the client. This request comprises information identifying the container corresponding to the client. This request is received by the HSM through the host interface.

In step 502 the container identified in the request is launched, or run in the HSM device. A launcher program running on the HSM device receives the request and launches the container. As has been described previously, this involves providing a command to start the corresponding container to the container engine. The container engine then retrieves the container files, and makes one or more API calls to the operating system kernel. The container files and other per-container data are loaded into a part of the RAM 309 corresponding to the container. This includes a secure connection process for establishing and communicating over a secure connection. Once a container has been started, the launcher is configured to transmit to the client (via the host system device 50) information about the container allowing the client to connect to it, for example a network address of the container. This then allows a secure connection using the SSH protocol to be established with the container in step 503.

In this example, the HSM device 21 appears to the host system device 50 as if it is connected over a local-area network. When the container is started, the network address of the container is transmitted to the client device. In this manner, communication can be established by the client device with the container through the host system device 50 using the network address of the container. Communication from the client device is sent to the host system device together with the network address of the container. The host system then uses the network address to route the communication to the container.

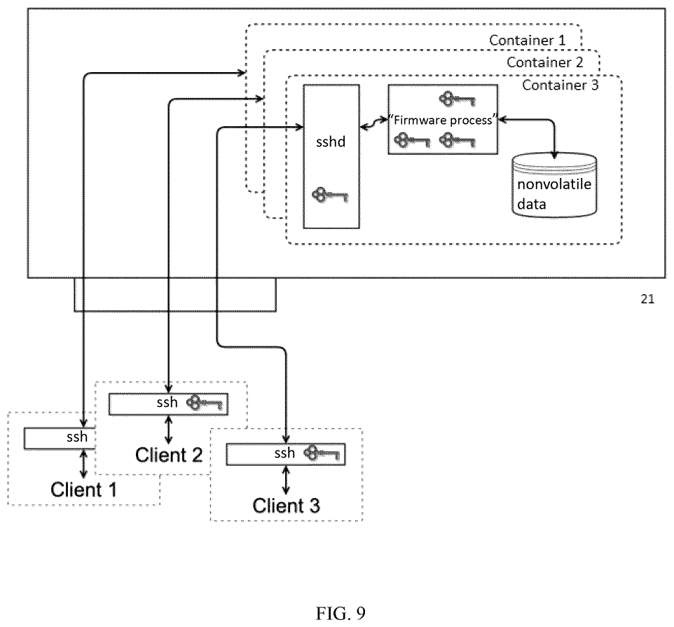

In step 503, a secure connection is established between the client system and the container. The secure connection is established by the secure connection process running in the container, and a secure connection process running on the client system. This step further comprises authenticating the client. FIG. 9 shows a schematic illustration of a hardware security module 21 in accordance with an embodiment, illustrating use of the hardware security module 21 to establish a secure connection between containers and clients. The process for establishing a secure connection will be described in relation to this figure.

The secure connection is established directly to the container within the HSM device 21. This means that the host system device 50 does not have to separate tunnel traffic and ensure that client commands are executed with the correct keys.

In an embodiment, the secure connection is established using the SSH protocol. FIG. 9 shows a schematic illustration of a system comprising a HSM device in accordance with an embodiment, where secure communication between each client device and the container is performed using the SSH protocol.

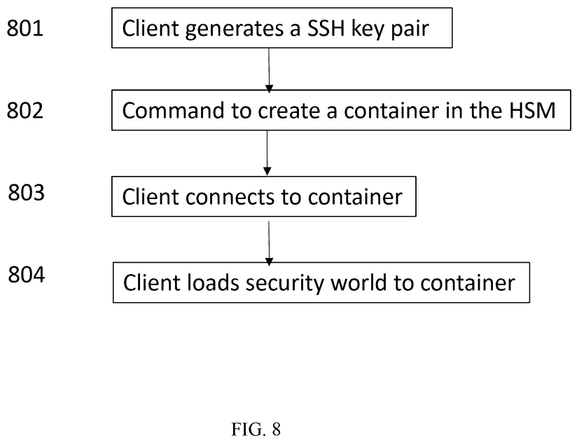

A first SSH key pair comprises a first private key at the client system, and a first public key stored in the per-container data with the corresponding container at the HSM 21. The secure tunnel information is a SSH key pair shared between the client device and the corresponding container. The SSH key pair comprises a first private key and a first public key. The client device stores the first private key, while the first public key is enrolled with the container when the container is first created. The process of creating the container and enrolling the first public key will be described in more detail in relation to FIG. 8 below. The first SSH key pair allows the container to validate that the connection is terminated by the correct client.

Similarly, a second SSH key pair comprises a second private key stored with the container data. This means that the client can be assured that their connection is genuinely being terminated by the right container. The second SSH key pair is also shared between the container and the client device. The second private key is stored with the container and the second public key is enrolled with the client device. The second SSH key pair provides trust for the client that the connection is genuinely terminated by the right container.

The security boundaries are shown in FIG. 9, which is a schematic illustration of a device according to an embodiment, in which a secure connection is made to each client system using the SSH protocol. Each client shares secure tunnel information with the corresponding container. The secure tunnel information is used to establish a secure communication tunnel between the client device and the container in the hardware security module 21. FIG. 9 shows three clients connected to the hardware security module. Each of the client 1, client 2, and client 3 are connected to the corresponding one of the container 1, container 2 or container 3.

The client devices use the Secure Shell (SSH) protocol for communicating commands to the container in the hardware security module 21. As shown in the figure, each client device comprises a SSH process, also referred to as an SSH client. This process is a running instance of a program which uses the secure shell protocol to connect to a remote device, in this case the container in the HSM device 21. The private half of the first SSH key pair is loaded into the memory space of the SSH process at the client device. The public half of the second SSH key pair is also loaded into the memory space of the SSH process at the client device.

As shown in the figure, each container also comprises a SSH process, also referred to as an SSH server. This process is a running instance of a program which uses the secure shell protocol to accept a connection from the client system. The private half of the second SSH key pair is loaded into the memory space of the SSH process. The public half of the first SSH key pair is also loaded into the memory space of the SSH process.

In 503, a request to establish the secure connection is transmitted from the client device to the container in the hardware security module, using the network address of the container provided in 502. The request comprises connection information. The connection information may include the client network address. It may further comprise information about the client identity, for example a username. Both the SSH client on the client device and the SSH server in the container have a corresponding network address. These are used by the host system and the HSM device 21 operating system to ensure the SSH protocol's messages are delivered to the expected processes. At least part of the connection information sent from the client to the container is signed with the first private key. For example, in the SSH protocol, the client network address is not signed with the first private key, while the content of the messages is signed with the first private key. The connection information may also include identification of a port number of the hardware security module, which is used to indicate the type of service of the hardware security module the client device is requesting. For example, the type of service of the hardware security module may be “administrative” or “main”. “Main” service refers to the cryptographic functions performed by the hardware security module.

The connection information comprises information used to identify the container to which the request is directed, i.e. the network address of the container provided in 502. This information is used by both the operating system running on the hardware security module and the operating system running on the host system to route the connection messages between the client device and the corresponding SSH process in the container.

The connection information is loaded into the memory space of the specified container. In particular, the connection information is loaded into the memory space of the SSH process in the specified container. The SSH process running in the container validates the signature using the first public key. If the validation is successful, the container confirms that the connection between the client device and the corresponding container is validated. In other words, the container authenticates the client. If the signature is not validated, the connection is denied and an error message sent to the client system.

If the container confirms the connection, i.e. the client is authenticated, the container generates a response. The response includes the client network address so that it can be routed correctly. At least part of the response is signed with the second private key. For example, in the SSH protocol, the client network address is not signed with the second private key, while the content of the response is signed with the second private key. The response is transmitted from the HSM device 21 to the specified client system. The SSH process running in the client system validates the signature using the second public key. If the validation is successful, the client system confirms that the connection between the client device and the corresponding container is validated. If the signature is not validated, the connection is denied and an error message sent to the container.

Optionally, a client may be using a third-party service provider to run their machine. In this case, the client system may operate a shielded virtual machine on the service provider machine. The shielded virtual machine is used to store data in a manner which is not accessible to the client system administrator. In particular, the SSH key may be protected by running a shielded virtual machine. This is used to establish the secure tunnel between the virtual machine running on the service provider system and the corresponding container running inside the HSM device 21. Trusted systems are used by the client to store the secure tunnel information in isolation from the rest of the client system and the client system administrator.

If the connection is validated by both the container and the client system, a communication encryption key is then generated and exchanged between the container and the client system in step 504. For example, the client system may generate a symmetric key, encrypt the symmetric key with the second public key, and send the encrypted symmetric key to the container. The encrypted symmetric key is then loaded into the memory space of the SSH process running in the container, and decrypted using the second private key. The decrypted symmetric key is then stored in the container data. Using a symmetric key for encrypting communications is more efficient than using the asymmetric key pairs. The symmetric key is then used to encrypt communications between the client system and the container.

In 505, a command is sent from the client system to the hardware security module 21, corresponding to a cryptographic function. The command is encrypted with the symmetric communication key. The message also comprises information specifying the container to which the command is directed, i.e. the network address. The encrypted command is loaded into the memory space of the specified container. In particular, the encrypted command is loaded into the memory space of the SSH process in the specified container. The command is decrypted using the symmetric key. The decrypted command is then loaded into the memory space of the firmware process in the container. The firmware process executes the command in 506. If the command is not decrypted successfully, it is not passed to the firmware process.

For example, program instructions corresponding to cryptographic key generation; cryptographic key derivation; encryption; decryption; or digital signature functions (for example digital signing or validation of a digital signature) are executed. The program instructions may be executed using the application keys which were loaded into the memory space of the firmware process.

In some instances, the firmware process may require an additional level of authentication before it executes the command. For example, the firmware process may require the client to present a smart card to the container and to input a passcode.

The output of the firmware process is then passed to the SSH process. The output is encrypted with the symmetric key, and transmitted to the client system. For example, if the client has requested generation of a new cryptographic key, the response will comprise an identifier of the new cryptographic key. If the client has requested to use a cryptographic key to decrypt textual information, the response will comprise the decrypted text information. A client may also send a status check request and the response will confirm whether a command has been successfully executed or not.

The secure connection between the container and the client system means that the host system administrator is unable to read or modify the command traffic between each client and the hardware security module. Furthermore, a client will be unable to read or modify the command traffic of another client, even in an event of network misconfiguration. The secure connection enables the client device to communicate with the hardware security module and vice versa without the security relying on the traffic being correctly directly between them. For example, if the HSM device 21 mistakenly sends data associated with client 1 to client 2, client 2 will not be able to access the data, since client 2 does not have the necessary information to decrypt the data. If the HSM device 21 mistakenly sends a command from client 1 to client 2 container, container 2 will not be able to access the command, since container 2 does not have the necessary information to decrypt the command. The command will therefore not be executed.

The secure channel allows for separation between the communication channels of different clients and their corresponding containers, as well as restricting the access of the host system administrator to the data being communicated between the client devices and the hardware security module 21. As shown in FIG. 9, container 1 shares secure tunnel information with client device 1, container 2 shares secure tunnel information with client 2 and container 3 shares secure tunnel information with client 3. The secure tunnel information allows the HSM containers to verify that commands sent to container 1 are really sent by client 1. It is not possible for client 2 to send commands to exploit a vulnerability in firmware running in container 3, since client 2 and container 3 do not share secure tunnel information. Furthermore, it is not possible for client 2 to simply send commands which make ordinary use of keys loaded in container 3, since client 2 and container 3 do not share secure tunnel information.

Role separation is provided between the host system roles (including network and hardware administration) and security administration roles, since each client retains control of keys and cards. Smart cards may be used to deliver a security world key, for example to a new HSM device joining the security world, or to a new container joining the security world. The key data is split onto several smart cards, and loaded from the smart card onto the HSM and/or into the container. Where a new container is joining the security world, the security world is associated with that container and not the HSM as a whole. The key is loaded from the smart card into the container using the secure tunnel. Furthermore, since the network traffic uses a secure tunnel, the host system has no access to commands and data.

When a new client wishes to enrol with the hardware security module, an enrolment process is performed. To ensure that the initial system setup is secure, and a man-in-the-middle cannot be established by the system administrator, the enrolment process is protected by ‘certificates’, signed by the unique identity key of the manufacturer of the module. The use of a manufacturer key to validate the enrolment of the secure tunnel key ensures that the initial system setup is secure. An example of a process of enrolment will be described with reference to FIG. 8. The process may be used with the hardware security module as described in relation to FIGS. 4 to 6 for example.

In step 801, the client generates a first SSH key pair, comprising a first public key and a first private key. The first SSH key pair is associated with the client and identifies the client.

In 802, a command to create a new container associated with the key pair is sent to the HSM. This is sent through the device 50 in the host system, in the same manner described previously. The first public key is provided to the hardware security module, to be associated with the new container.

The hardware security module 21 receives the client request and generates the container image, including the public half of the client SSH key pair. The generated container image comprises a second SSH key pair. Information identifying the container, including the second public key is sent to the client. Information proving the origin of the information identifying the container as being a trusted device is also sent.

For example, referring back to FIG. 5, the hardware security module stores a manufacturer asymmetric key in the system data 315. The manufacturer may be a trusted party who manufactured the hardware security module. The hardware security module also stores a unique asymmetric identity key in the system data 315. This key is generated in the factory when the HSM was manufactured for example, and may be used to prove the origin of data and authenticity.

A key-generation certificate for the identity key may also be stored, which is signed using the manufacturer private key. The key generation certificate may describe the public parameters of the key, for example, the key generation certificate may include information relating to the type of the key, and its length. The key generation certificate comprises information which authenticates that the identity key was generated in the HSM device. For example, the key generation certificate may include a hash of the public half of the identity key, and be signed by the private half of the manufacturer key.

The hardware security module can be verifiably identified using the signed key generation certificate generated at the time of manufacture. It is able to securely store its identity in a way that means it cannot be imitated. The client system can use the public half of the manufacturer key as the root of trust to authenticate that the hardware security module is a genuine appliance. Furthermore, the parameters and state of the hardware security module can be validated in a non-repudiable manner through exchange of certificates signed by the identity private key or the manufacture private key.

For example, an initial step of authenticating at the client that the identity key was generated in the HSM device may be performed using the key generation certificate. The public half of the second SSH key pair is then validated by the identity key of the hardware security module device, which is unique to the hardware security module. For example, the second public key is sent to the client device together with a certificate signed by the identity key. This certificate may specify further information such as the firmware version, or information about the HSM configuration. In the instances where the hardware security module comprises two or more containers, the same HSM identity key may be used to validate the public half of the second SSH key pairs associated with each one of the containers.

Information is also provided to the host device 50 in step 802, identifying the container as corresponding to the client. The host system administrator has the responsibility for managing the containers of the hardware security module. For example, the host system administrator uses this information to associate a container identity with a client identity, and requests that the HSM starts up a particular container when a client makes a request.

In step 803, the client establishes the secure connection with the container in the manner described previously in relation to FIG. 7.

In step S804, once the secure connection is established, the client enrols the container in the security world. This comprises loading one or more master keys in the container. These are transmitted over the secure connection, i.e. encrypted using the communication key. In order to load the master key, the client may be required to present various smart cards, on which the master key is stored, and optionally to input a passcode, validating the use of the smart card. The master keys associated with a client may be divided onto two or more smart cards, and in order to enrol the relevant container in the security world, more than one of the two or more client smart cards need to be presented to the container. Loading the security world to the container is the final step of the process of enrolling a client with the hardware security module 21. Once the security world is loaded to the container, the container is ready for use by the client.

Within each security world, admin cards and operator cards work as normal. For example, the admin cards may be presented to the hardware security module when the container is first enrolled to the security world, while the operator cards may be associated with particular application keys, stored in the container or stored in an encrypted form outside the container. The container may require the presentation of operator cards in order to verify some operation with the associated application keys.

As has been explained in relation to FIG. 8, new clients do not require an intermediate hardserver to be configured, but may connect directly to the container by running a secure communication process, for example an SSH process. The system requires minimal administration, for example no hardserver configuration is required.

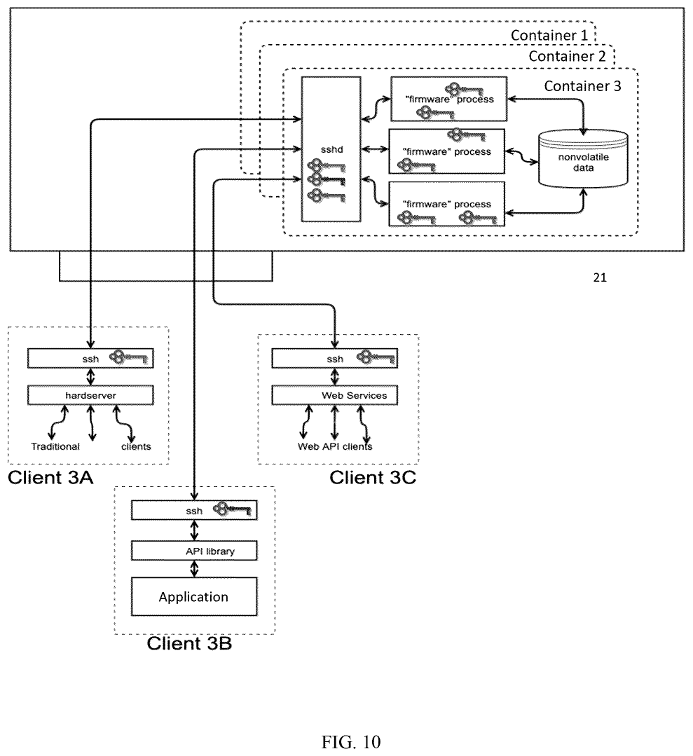

In the above description, a one to one correspondence between each client system and each container has been described. FIG. 10 illustrates a hardware security module in accordance with an embodiment, where three client devices (Client 3A, Client 3B, and Client 3C) are connected to the same container of the hardware security module. In this system, multiple clients are enrolled in the same security world, i.e. they share the same set of one or more master keys. This system may be used in a scenario where one company has multiple client systems at different locations, for example. Each client system is connected to the container through a secure connection. The container corresponds to three clients, i.e. all three clients are connected to container 3 simultaneously.

The SSH process of the container 3 stores the public halves of the first SSH key pairs associated with each of client 3A, client 3B and Client 3C. It also stores the private half of the second SSH key pair as before. A new container is created as described in relation to FIG. 8, by client 3A for example. Client 3A is then authorised to add additional client(s) to the container, by providing the container with a public key identifying the additional client(s). Thus each additional client generates an SSH key pair, provides the public key to client 3A, and client 3A provides the public key to the container.

The system is thus configured such that each container can accept more than one incoming connection simultaneously. The SSH process of the container may be configured to accept new connection requests, while the container is already in connection with another client or clients. When a new connection request is received and the request is successfully validated by the SSH process, a new firmware process is started in the container. Each connection uses its own copy of the firmware process in the container. This allows multiple clients to connect to one container, i.e. to share security world data.

The figure also illustrates various ways in which a client system may connect to the HSM device.

Client 3A is an existing client application, which may use a PKCS #11 interface. In the client 3A system, multiple client devices access the HSM through a central client device, which may be a client computer device or server for example. A hardserver process runs on this device. In order to connect to a container, the hardserver code is modified to include the SSH functionality. In this way, the hardserver process used in an existing set-up is modified to connect with a container, by including the SSH functionality in the hardserver process. All users at client 3A share the same hardserver process and hence the same SSH key pair. If a user requires to connect to a different container of the hardware security module 21, then a new hardserver process is set up on the central device. As the SSH protocol functionality is implemented in the hardware process, the existing users of client application 3A are not required to implement any changes to their existing setups in order to connect and communicate with hardware security module 21.

Client 3A uses a hardserver process running on its local host machine connecting to the container. The hardserver process is configured to establish a connection with the corresponding container. This configuration is useful for a legacy application, which is instead run over the cloud. In this manner, the client can “rent” containers from the host system according to their capacity needs, instead of requiring dedicated HSM hardware. In this system configuration, the client is a hardserver process. The ability to present a full “virtual HSM” to clients to lift and shift existing on-premise applications is provided.

Clients which are capable of establishing their own SSH connection with the hardware security module do not need a hardserver program. The inconvenience of having to install and run this extra hardserver process can be eliminated for such clients. Client 3B uses a directly-connected version of the API library (libnfstub) to make connections between an application running on a client machine and the container. The API Library is modified to support the SSH functionality, in order to communicate with the container. The application may be a banking application for example.

The use of the API library eliminates the need for a hardserver process. The client application could, for example, be hosted directly inside a Docker container running on a client machine with minimal configuration required. Running the client application in a Docker container allows the client to add more copies of the application if needed, perform updates, or transfer the application to a different machine with minimal disruption. In this case, the client uses the SSH public key to identify itself. The private SSH key is securely stored in the container. As described above, each copy of the client application running in the Docker container will have its own network address. This is used by the operating systems on the host machine and the HSM 21 to establish the network connection between the container and the client. However, the network address for the client does not need to be enrolled with the HSM 21 beforehand. As described above, the container in the HSM 21 does not use the network address to confirm the client identity. Instead it uses the SSH public key. In this manner, if new copies of the client application are added, each of which will have a new network address but the same SSH public key, they can connect immediately to the container in the HSM 21, with no further HSM administration to be performed.

Client 3C uses an instance of a web service, configured to connect to the hardware security module. While client 3C refers to a single client, it is understood that there could be two or more clients using the web service. The web service is modified to support the SSH functionality to communicate with the containers. The web service runs on a machine of a trusted party, for example a trusted party who supply and administrate the HSM. The client 3C connects to the container via the web service, i.e. through a public web interface. Alternatively, a client organisation may run a web service server themselves, including the SSH functionality, and the various users connect via the Intranet. The web service can serve many clients via a Representation State Transfer (REST) interface. The REST Interface is suited to environments where there are many potential clients and it may be impractical to manage individual connections (and their associated credentials) directly with the HSM. A REST interface provides means for implementing a web service interface for communication with the HSM. A host system may comprise one or more HSMs which are PCI plug-in boards in a rack PC chassis. The hardware security module may be implemented as a multi-tenant HSM in a network-connected form factor. A processor in the PC chassis may be a x86 processor. The processor is configured to move data between the hardware security module and the network, i.e. Internet connection. The processor also runs a management software for administering the HSM.

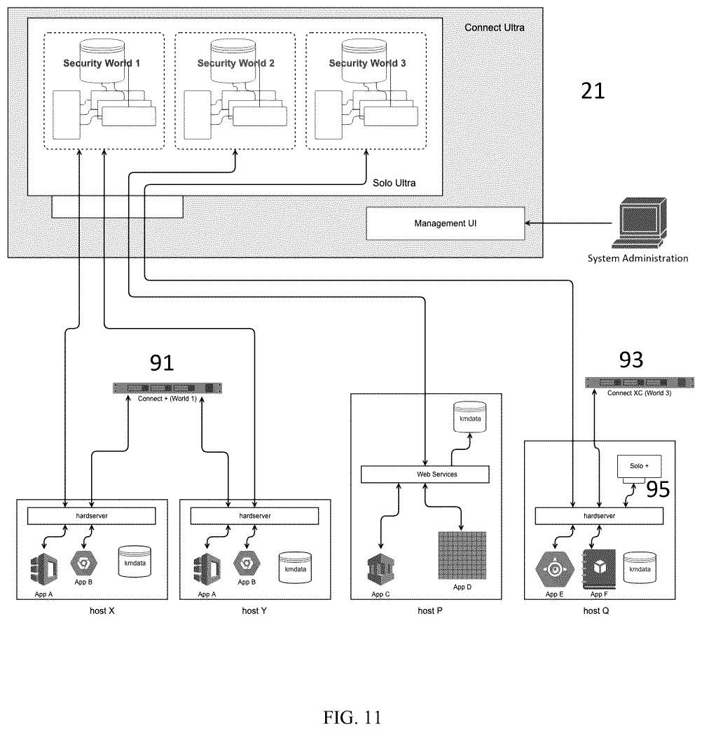

A new HSM can be used to add capacity into an existing deployment of HSMs, as shown in FIG. 11. FIG. 11 is a schematic illustration of a system comprising a new hardware security module 21. FIG. 11 aims to demonstrate how clients using a variety of hardware security modules can extend their functionality by connecting to hardware security module 21. A first host system, host X, and a second host system, host Y, are coupled to a first existing HSM 91. A third host system, host Q, is coupled to a second existing HSM 93. The new HSM 21 is used to add extra capacity to the host systems.

The new HSM 21 is coupled to a system administration computing device, through a management user interface. The new HSM device 21 is managed by a system administrator using a local console. The system administrator does not have access to the application keys, or to the command and reply traffic between the client devices and the new hardware security module 21. Furthermore, as all the traffic between the new hardware security module 21 and the connected hosts uses secure communication, for example the secure shell SSH protocol, only a single network port needs to be opened for the new hardware security module 21 (the port in which the SSH runs). If there are existing network firewalls between hosts X, Y, P and Q, these can remain.

There are three containers defined and running concurrently in the hardware security module 21. Each container may comprise a different version of a firmware process and, as shown in FIG. 11, each container can be enrolled in a different security world.

The figure shows four client devices connected to the hardware security module, labelled Host X, Host Y, Host P and Host Q—these are machines run by different customers. Both Host X and Host Y are each running Application A and Application B, using security world 1. The security world data is stored in the km data in the host machines. Examples of applications A and B include but are not limited to web servers providing websites to banks, applications providing electronic signatures or data base encryption applications.

Host X and host Y are currently sharing a first HSM 91 enrolled into the security world 1. Host X and host Y use a hardserver process to connect to the first HSM device 91, enrolled in security world 1, to deliver cryptographic services to the applications. As explained above with reference to FIG. 10, the hardserver process of the host X and host Y is modified to include the SSH functionality, allowing communication with the “security world 1” container in hardware security module 21. The new HSM 21 is used to add capacity for host X and host Y. A container 1 is created on the new HSM device 21, and security world 1 is installed on it. The hardserver process on each of host X and Y is configured to connect to this container. App A and App B do not change; the new HSM device appears as an extra available HSM. The hardserver process can load-balance between the new HSM device 21 and the first HSM device 91.

Host P runs Application C and Application D which are clients of the web services. These have their own security world 2. The web services have been modified to support the SSH protocol, as described above in relation to FIG. 10. A new container 2 is created on the new FISM device 21 and security world 2 installed on this. Application C and Application D keys can be added to the new HSM 21 and administered independently of the others. Given sufficient overall processing capacity in the new HSM 21, this can be done without the need for new hardware.

Host Q runs applications E and F, and uses the second HSM 93 enrolled into security world 3, as well as a local HSM 95. As with hosts X and Y, the new HSM 21 is connected up to host Q's hardserver, which has been modified to support the SSH protocol as described above, and appears alongside the existing second HSM 93 and local HSM 95. Host Q uses a hardserver process to connect to the second HSM 93 and the local hardware security module 95, both enrolled in the security world 3 framework. The hardserver process is also configured to establish connection with a third container 3 in which security world 3 is installed defined in the new hardware security module 21.

In this system, existing HSMs continue to work alongside new HSMs, so existing capacity is not lost.

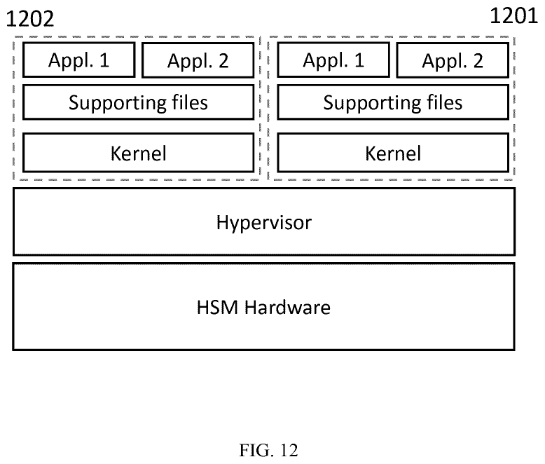

In the above description, the isolated environment associated with the each client is a container. However, alternatively the isolated environment may be a virtual machine for example. A schematic illustration of two virtual machines running on the HSM device 21 is shown in FIG. 12. Again, the virtual machine comprises a set of one or more processes that are isolated from the rest of the system. In this case, a separate kernel runs in each virtual machine. The first virtual machine 1201 comprises application 1, application 2, the supporting files for these applications and the kernel. The second virtual machine 1202 comprises application 1, application 2, the supporting files for these applications and the kernel. A hypervisor comprises software that creates and runs the virtual machines, and acts as an intermediary between the virtual machine and the HSM hardware.

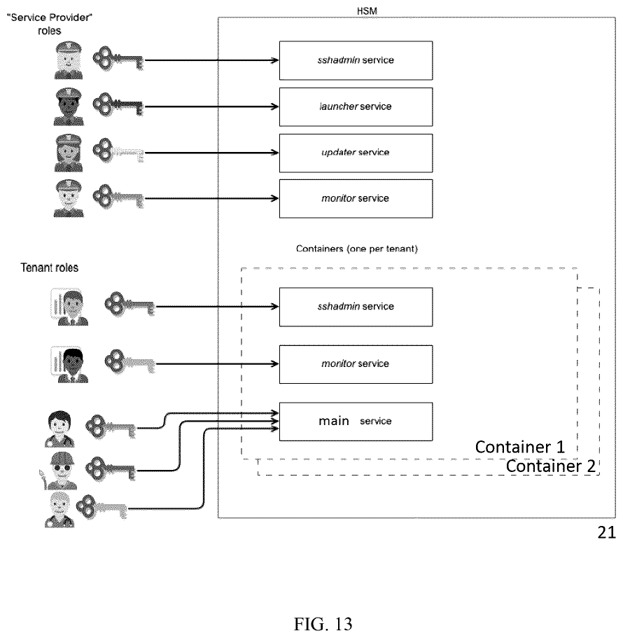

FIG. 13 shows a schematic illustration of a hardware security module device 21 in accordance with an embodiment. The HSM device 21 may be a HSM device 21 such as described in relation to any of FIGS. 4 to 12 above for example. In this example, a number of different credentials are used in a multi-tenant HSM device 21. In this example, the credentials are SSH key pairs.

The HSM device 21 is located in a host system (not shown), which in this example is a service provider system. The HSM 21 is communicatively coupled to a first computing device, which may be a computer or server device in the host system, by a direct connection. For example, the HSM device 21 may be a PCI-express card, directly plugged in to a PCI-express card slot of the first device. The host system is associated with a first party, referred to here as the service provider. The service provider may be an organisation which owns the HSM 21 and leases it out to tenants. There may be a number of end-user computing devices which are part of the service provider system, in addition to the first computing device. These additional devices may be desktop computers, laptop computers, mobile devices or other devices for example. Communication between the additional devices in the host system and the first device in the host system is performed over a communication network.

A tenant or client system, which is separate to the host system, is located remotely from the host system. The tenant system comprises a second computing device, which may be a computer or server device. There may be a number of end-user computing devices which are part of the tenant system, in addition to the second computing device. The device(s) in the tenant system are communicatively coupled to the first device in the host system, and thus communicatively coupled to the HSM device 21 through the first device. Communication between the tenant system and the host system is performed over a communication network. The tenant system is associated with a second party, referred to here as tenant 1, which may be an organisation.

The hardware security module 21 is illustrated here with two containers running: ‘container 1’ and ‘container 2’. However, there may be one or more containers. In one example, there is one container per tenant. In this example, container 1 is associated with tenant 1.

The first device in the service provider system communicates with the HSM device 21. In this example, the first device in the service provider system communicates with one or more processes running in the HSM device 21 outside of any container. Each process is also referred to here as a “service”. Each service corresponds to a program, comprising computer program instructions embodying a set of one or more actions. The service process refers to the service program in execution, in other words it is a running instance of the service program. In this example, there is an “ssh admin service”, a “launcher service”, an “updater” service and a “monitor” service. These services are all “administrative”. Each service is associated with a separate secure connection. In this example, each secure connection corresponds to an SSH server, together with an SSH key pair, and the public key of another SSH key pair. For example, the “ssh admin” service is associated with a first SSH server which runs outside of any container, together with a “first service” SSH key pair and the public key of a “first service provider role” SSH key pair. The “launcher” service is associated with a second SSH server, together with a “second service” SSH key pair and the public key of a “second service provider role” SSH key pair, and so on. These credentials are used to set up the secure channel between the service provider system and the service.

The Secure Shell (SSH) protocol is used to provide a secure connection between the service provider system and the service running on the hardware security module 21. An SSH server configuration specifies which process should be started when an SSH client connects—such as a “shell” program which allows the user to issue general commands. In this example, the SSH server configuration specifies a service process that is started when an SSH client connects to the SSH server. For example, the first SSH server specifies that the “ssh admin service” process should be started when an SSH client connects to the first SSH server. When an SSH client successfully establishes a connection with the first SSH server, the first SSH server requests the hardware security module 21 to initiate the ‘ssh admin service’. Each service provider role has a corresponding ‘service’ process, which only allows commands appropriate to that role.

In this example, there are a number of different service provider roles. Each role has its own credential, and is allowed to connect to a different service process running on the HSM device 21. In this example, each service provider role corresponds to a different person within the service provider organisation. Each different service provider role is also referred to here as a “first host”, “second host” and so on. In other examples, a person may hold two or more roles, or two or more people may hold one role. In this example, each service provider role uses a different end-user computing device within the service provider system. Alternatively or additionally however, people holding different roles may use the same end-user computing device within the service provider system, which may be the first device for example. The person(s) corresponding to the service provider role holds the credential associated with the role, which in this example corresponds to a private SSH key as described below. The credential may be stored on an end-user computing device associated with that person (for example a laptop encrypted with a password and/or other security measures) or on one or more smart cards for example. Where more than one person is authorised for a service, in other words more than one person holds the service provider role, they may each have their own credentials. In this case, there is more than one credential associated with the role and with the secure connection. For example, each person may hold a private SSH key which can be used to establish a secure connection with the SSH server associated with the service.

While the tenants communicate with SSH servers inside their respective containers, the service provider communicates with SSH servers outside the containers. A corresponding SSH client runs in the host system device used by the service provider role. The service provider role has its own credentials, which establish a secure channel to the SSH server which runs outside the containers. Each of the service provider roles corresponds to a different service (“updater”, “launcher”, and so on) and has their own SSH client and server running, where each SSH server running in the HSM is configured to accept connections authorised by a different credential.

As has been described previously in relation to the SSH protocol, the messages exchanged when setting up a secure connection are digitally signed, and each end of the connection checks the signatures made by the other. The signature verification key is part of the SSH server configuration, so the SSH server at the HSM device 21 will check that the connection is being established by an SSH client with the corresponding signature key—this key is the service provider role's credential. Each service provider role has its own set of keys, with the signature verification key for each role being established in the corresponding SSH server's configuration data.

For example, in relation to the “ssh admin” service, there is a “first service provider role” SSH key pair comprising a “first service provider role” private key and a “first service provider role” public key. The service provider role stores the “first service provider role” private key. For example, this key may be stored on one or more smart cards or on an end-user computing device. The “first service provider role” public key is stored in the HSM device with the first SSH server information. The “first service provider role” public key is the signature verification key which is part of the first SSH server configuration. The “first service provider role” private key is the signature key. The “first service provider role” SSH key pair allows the HSM device 21 to validate that the connection is terminated by the correct service provider role. Another SSH key pair, referred to here as the “first service” SSH key pair, comprises a “first service” private key stored with the SSH server data on the HSM device 21. This means that the service provider role can be assured that their connection is genuinely being terminated by the right SSH server. The “first service” public key may be stored on the host system device for example.

A request to establish the secure connection is transmitted from the host system device to the hardware security module. Where the service provider role uses a host system device separate to the first device, the request is sent via the first device. The request comprises connection information. The connection information may include a network address. Both the SSH client corresponding to the service provider role on the host system device and the SSH server corresponding to the service on the HSM 21 have a corresponding network address. The connection information may also include identification of a port number of the HSM 21, which is used to indicate the service of the hardware security module being requested. These are used by the host system device(s) operating system and the HSM device 21 operating system to ensure the SSH protocol's messages are delivered to the expected processes. At least part of the connection information sent from the host system device to the HSM device 21 is signed with the “first service provider role” key. For example, in the SSH protocol, the network address is not signed, while the content of the messages is signed.

The connection information is loaded into the memory space of the first SSH server process. The SSH process running on the HSM device 21 validates the signature using the “first service provider role” public key. If the validation is successful, the HSM device 21 confirms that the connection is validated. If the signature is not validated, the connection is denied and an error message sent. If the HSM 21 confirms the connection, it generates a response. The response includes the SSH client network address so that it can be routed correctly. At least part of the response is signed with the “first service” private key. The response is transmitted from the HSM device 21 to the host system device. The SSH process running in the host system device validates the signature using the “first service” public key. If the validation is successful, the host system confirms that the connection between the host system device and the corresponding HSM service is validated. If the signature is not validated, the connection is denied and an error message sent. If the connection is validated, a communication encryption key is then generated and exchanged between the HSM and the host system device.

Although in the above example, each service is associated with a single credential, in some examples a service may be associated with two or more credentials. In this case, the SSH server corresponding to the service stores public keys associated with more than one person, so that more than one person may be authorised to access a service and assume the associated service provider role. For example, there may be more than one person, each person with their own credentials, who are authorised to connect to the “SSH admin” service. When one of these people connects to the “SSH admin” service, this person assumes the “SSH admin” role, even if there are other people also authorised to assume the “SSH admin” role.

The services run outside container 1 and container 2 and are thus separated from the firmware processes running in the containers. The tenants only have access to their associated containers. Service provider services are only accessible by the service provider role, and are not accessible by the tenants. Each role is identified by its own credentials. System administration roles may use the credentials to set up a secure communication channel with the service process. Each role may access only specific services of the hardware security model 21, and thus only perform a specific set of actions. The HSM 21 supports a number of different service provider credentials, in this example corresponding to a number of public keys, which are for service provider users acting in different roles. For instance, one role may perform a firmware upgrade, another may request a “factory reset”, and so on.

In the example of FIG. 13, there are four services. In other examples, one or more of these services may be used, or additional or alternative services may be used.

The “ssh admin service” comprises a set of actions relating to setting up service provider role credentials for other service provider roles within the hardware security module 21. Setting up service provider credentials may comprise enrolling a service provider role public key with the SSH server of a service process. This configures the SSH server's signature verification key.

The “launcher service” process allows existing containers to be initiated when a client connects. Launch of a container is performed following the steps described above in relation to FIG. 7 for example. In the example of FIG. 13, when an initial request to start a container is received from a client system by the service provider, the service provider role authorised to access the “launcher service” process establishes a secure connection with the second SSH server corresponding to the “launcher service” on the HSM 21, and sends the request using the secure connection to the hardware security module device 21 to run the relevant container. The launcher service may both start and stop containers from existing images.

The launcher service also allows containers to be created and deleted, as tenants come and go. The launcher service therefore can also create new container images, for example when a new tenant is enrolled on the system. The enrolment process is performed following the steps described above in relation to FIG. 8 for example. In the example of FIG. 13, when the command to create a new container associated with the key pair is sent to the service provider system, the service provider role authorised to access the “launcher service” process establishes a secure connection with the second SSH server corresponding to the “launcher service” process on the HSM 21, and sends the request using the secure connection to the HSM 21.

The “updater service” allows the firmware to be updated.

The “monitor service” allows system logs and status information to be read out. By accessing the monitor service, the service provider can access and read out system logs and status. For example, the status information may indicate how the resources of the hardware security module 21 are being used, i.e. how ‘busy’ the hardware security module 21 is, what is the operating temperature of module and other information relating to the state and operation.

In FIG. 13, there also exist different roles within the tenant system, where certain tenant roles may only have access to certain processes within the container associated with the tenant. FIG. 13 shows various tenant roles for tenant 1.

Each “tenant” is associated with a container. Each tenant has its own set of credentials, which are independent from the service provider's various credentials. Once a tenancy has been created, the service provider cannot interfere with the tenant's credentials, and for example cannot intercept their secure connections. Each tenant may have multiple people associated with the tenant, also referred to here as multiple entities, each with their own credential.

Each process is also referred to here as a “service”. Each service corresponds to a program, comprising computer program instructions embodying a set of one or more actions. The service process refers to the service program in execution, in other words it is a running instance of the service program. In this example, there is an “ssh admin service”, a “monitor” service and a “main” service which run within container 1. Each service is associated with a separate secure connection. In this example, each secure connection corresponds to an SSH server, together with an SSH key pair, and the public key of another SSH key pair. In this example, the “main” service is associated with multiple public keys from multiple SSH key pairs, allowing multiple people to access the main service. The SSH server associated with the main service is an example of the SSH server described previously in relation to FIG. 9, where the “main” service corresponds to the “firmware process”. The “ssh admin service” and the “monitor” service are “administrative” services, whereas the “main” service performs the cryptographic functions.

In this example, there are a number of tenant roles associated with tenant 1. Each role has its own credential, and is allowed to connect to a service process running in the container 1 on the HSM device 21. In this example, each tenant role corresponds to a different person within the tenant organisation. In other examples however, a person may hold two or more roles, or two or more people may fill one role. In this example, a single tenant role corresponds to the “ssh admin service” and a single tenant role corresponds to the “monitor” service. However, three tenant roles correspond to the main service.

In this example, each tenant role uses a different end-user computing device within the tenant system. Alternatively or additionally however, people holding different roles may use the same end-user computing device within the tenant system. The person(s) corresponding to the role holds the credential associated with the role, which in this example corresponds to a private SSH key. The credential may be stored on an end-user computing device associated with that person (for example a laptop encrypted with a password and/or other security measures) or on one or more smart cards for example.

The SSH server configuration specifies the service process that is started when an SSH client connects to the SSH server. For example, an SSH server associated with the main service specifies that the firmware process should be started when an SSH client connects to the SSH server. Each service has its own SSH server running (in the tenant's container). Each SSH server has configuration which specifies the SSH key-pair which is allowed to connect to it, and which process should be run to handle requests made over the connection.

As has been described previously in relation to the SSH protocol, the messages exchanged when setting up a secure connection are digitally signed, and each end of the connection checks the signatures made by the other. The signature verification key is part of the SSH server configuration, so the SSH server at the HSM device 21 will check that the connection is being established by an SSH client with the corresponding signature key—this key is the tenant role's credential. Each tenant role has its own set of keys, with the signature verification key for each role being established in the corresponding SSH server's configuration data. Similarly to the secure communication channels described in relation to the service provider roles above, secure communication channels between the tenant roles and the processes are established using an SSH key pair, comprising a private key and a public key, associated with the tenant role, and another SSH key pair, comprising a private key and a public key, associated with the service within the container. The process of establishing the secure connection between the client role and the SSH server corresponding to the process within the client's container, is performed as described previously.

As described previously, both the SSH client corresponding to the tenant role on the client system device and the SSH server corresponding to the service in the container have a corresponding network address. These are used by the client system device(s) operating system, host system device(s) operating system and the HSM device 21 operating system to ensure the SSH protocol's messages are delivered to the expected processes. The connection information may also include identification of a port number of the hardware security module, which is used to indicate the service of the hardware security module the client device is requesting.

Each tenant role corresponds to a credential. The credential may be a private key of an SSH key pair. The role credentials are used to define different tenant roles. For example, some credentials may be associated with “administrative” roles within the container whereas some credentials may be associated with “main” type of services of the hardware security module, and thus do not grant access to administrative services. Each tenant may have these services available in their container.

In the example of FIG. 13, the container 1 is shown to comprise three processes running inside the container 1. The processes “ssh admin service” and “monitor services” are “administrative” services of the container, and are only accessible to tenants whose role is authorised to access these services. The “main service” relates to the “main” type of services provided by the hardware security module 21.

The “ssh admin service” allows a tenant's credentials to be set up with a service in the container, for example with the main service. Setting up a tenant's credentials may comprise enrolling a tenant public key with an SSH server of a service process. This is independent of the service provider ssh admin service. Once a container is created, the service provider cannot access the tenant's services. As explained above, once a container is set up within the hardware security module 21 for a specific tenant, only the tenant may access the processes running inside the container. Other tenants of the hardware security module 21 or the service provider do not have access to said processes.

The “monitor service” allows access to logs and status information which are private to the tenant's operations. The service may be used by the tenant role to access and read out system logs and status information which are private to the specific container and the tenant's operations.

The “main service” corresponds to the firmware process. The firmware process has been described previously, and provides the main functionality of the hardware security module 21 to users, including management and use of cryptographic keys. As the figure shows, the main service may accept a number of different credentials, corresponding to different people, also referred to here as different entities. The main service may further allow the keys it manages, including the application keys described previously, to have different levels of access depending on the credentials of the person making the request. For example, a particular key could allow only encryption for one person, and decryption for a second person. The application keys may comprise access control lists (ACLs) which specify the entities with each level of access.

The SSH server corresponding to the main service in this example is configured to accept any of a number of credentials, so that a number of different persons within the tenant system will be able to make connections to it. Each individual connection is private to the person that established it, since the SSH server will record which of the allowed SSH keys was used when the connection was being set up. This means that there may be a number of “cryptographic services users” who are all able to connect and use the application keys within the security world managed by the container.

In one example, one or more application keys may have an ACL entry which identifies the credential of the person who is allowed access to it. Several such entries in a single ACL will allow a number of different persons access to the application key. Within one security world, a number of different groups of applications keys may be managed, whose access is limited to a subset of persons within the tenant system. The application keys protected by the HSM 21 may each have an Access Control List which can allow different persons different permissions in a very flexible way. This allows strong isolation between different persons even within one tenancy.

For example, as illustrated in FIG. 13, the “main service” process may accept connections from three tenant persons. The SSH server of the “main service” process is configured to accept the credentials of three different entities, who all can establish a secure connection with the SSH server of the “main service” process and use the application keys within the security world managed by the container 1. The application keys within the security world may be associated with access control lists (ACL). The access control list may be used to define the different levels of access to the corresponding application key. The access control list may comprise an entry which defines the credential of a person who is allowed to use the associated application key, and optionally the type of cryptographic operation for which the person may use the keys. The access control list may comprise more than one entry, thus allowing a number of different persons to use the associated application key. Thus, the access control list may be used to define different groups of application keys of the security world which may only be used by a certain sub-group of persons in the tenant system. It should be understood that the “main service” process is not limited to three sets of credentials only, and more or less than three is possible.

Although in the above described example, there are multiple tenant roles and multiple service provider roles, it will be understood that in other examples, there may be a single service provider role and multiple tenant roles, or a single tenant role and multiple service provider roles for example. In the above described examples, each role is defined by a set of one or more SSH keys and configuration information specifying what those keys are allowed to do. Other types of credentials may be used however.

While certain embodiments have been described, these embodiments have been presented by way of example only, and are not intended to limit the scope of the inventions. Indeed the novel methods and apparatus described herein may be embodied in a variety of other forms; furthermore, various omissions, substitutions and changes in the form of methods and apparatus described herein may be made.

1. A device comprising:
an input;
a memory; and
a processor module, configured to:
store information in the memory defining a first isolated environment associated with a first user;
responsive to a request received through the input, run the first isolated environment;
authenticate the first user in the first isolated environment and, if the first user is authenticated, establish a first secure connection with the first user in the first isolated environment; and
responsive to a user command received over the first secure connection, execute, in the first isolated environment, a first operation corresponding to the user command.

2. The device according to claim 1, wherein the first operation comprises at least one of: cryptographic key generation, cryptographic key derivation, performing an encryption operation; performing a decryption operation and performing a digital signature operation.

3. The device according to claim 2, wherein a first master key associated with the first user is stored in the information in the memory defining the first isolated environment, wherein the first operation is executed using a first application key, and wherein the first application key is retrieved using the first master key.

4. The device according to claim 1, wherein a first public key is stored in the information in the memory defining the first isolation environment, the first public key being part of a first key pair comprising the first public key and a first private key associated with the first user.

5. The device according to claim 4, wherein a second private key is stored in the information in the memory defining the first isolated environment, the second private key being part of a second key pair comprising the second private key and a second public key.

6. The device according to claim 5, wherein authenticating the first user and establishing the first secure connection comprises:
receiving a communication comprising a first signature from the first user;
validating, in the first isolated environment, the first signature using the first public key;
generating a second signature using the second private key in the first isolated environment;
sending a communication comprising the second signature to the first user.

7. The device according to claim 6, wherein authenticating the first user and establishing the first secure connection further comprises:
encrypting a third key using the first public key in the first isolated environment and sending the encrypted third key to the first user, or receiving an encrypted third key from the first user at the first isolated environment and decrypting the encrypted third key using the second private key;
wherein the third key is used to encrypt communications between the first user and the first isolated environment thus providing the first secure connection.

8. The device according to claim 1, wherein the information in the memory defining the first isolated environment comprises information identifying program instructions which, when executed, cause the processor to perform the first operation.

9. The device according to claim 8, wherein a first version of the program instructions and a second version of the program instructions are stored in the memory, and wherein the information identifying the program instructions comprises an indication of the first version.

10. The device according to claim 1, wherein the processor module is further configured to:
store information in the memory defining a second isolated environment associated with a second user;
responsive to a request received through the input, run the second isolated environment;
authenticate the second user in the second isolated environment and, if the second user is authenticated, establish a second secure connection with the second user in the second isolated environment; and
responsive to a user command received over the second secure connection, execute, in the second isolated environment, a second operation corresponding to the user command.

11. The device according to claim 1, wherein the information stored in the memory defining the first isolated environment associated with the first user comprises an encrypted file.

12. A system comprising the device according to claim 4, and a first user device, wherein the first user device operates a shielded virtual machine, and wherein the first private key is stored in the shielded virtual machine.

13. A method of communication, comprising:
running a first isolated environment corresponding to a first user on a device in response to receiving a request;
authenticating the first user in the first isolated environment and, if the first user is authenticated, establishing a first secure connection with the first user in the first isolated environment;
receiving a user command over the first secure connection; and
executing, in the first isolated environment, a first operation corresponding to the user command.

14. A method of creating an isolated environment, comprising:
receiving a request to create an isolated environment associated with a first user;
creating the first isolated environment associated with the first user;
establishing a secure connection with the first user in the first isolated environment;
receiving information allowing performance of one or more operations in relation to the first user over the secure connection.

15. A non-transitory computer readable storage medium comprising computer readable code configured to cause a computer to perform the method of claim 13.

16. A non-transitory computer readable storage medium comprising computer readable code configured to cause a computer to perform the method of claim 14.
